(19) United States
(12) Patent Application Publication
(10) Pub. No.: US 2004/0112881 A1
(43) Pub. Date: Jun. 17, 2004

(54) Circle laser trepanning

(76) Inventors: Stephen Roger Bloemeke, Long Beach, CA (US); Pierre Lespes, Lesigny (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/474,253

(22) PCT Filed: Apr. 11, 2002
(86) PCT No.: PCT/US02/11032

(51) Int. Cl. B23K 26/38

(52) U.S. Cl. 219/121.71

(57) ABSTRACT

Vias (12) with substantially straight walls and no undercut regiosn at the bottom can be formed in a laminated substrate (10) by combining percussion drilling and trepanning drilling techniques and using different types of lasers. The top copper foil (13) of the laminated substrate (10) is first cut through, along the boundary of the via (12) to be drilled, to form a peripheral channel. This is accomplised by trepanning drilling using a UV laser (21). Then, an IR laser is applied to ablate the dielectric material (14) inside the via (12). During this step, a cutoff copper piece (40), which remains in the central regions of the via (12) after the trepanning drilling, will be removed as well. The IR laser reflects off a copper capture pad (131) at the bottom of the via (12), effectively cleaning the capture pad (131) surface for later plating processes.

### FIELD OF THE INVENTION

The present invention relates generally to the laser drilling of holes in components, and more particularly, to an advanced laser drilling technique which is especially suitable for forming vias in a multilayer substrate such as a printed circuit board.

### BACKGROUND OF THE INVENTION

As new printed circuit board (PCB) fabrication processes evolve to build high density substrates, the need for dense, cost effective PCB solution is immediate. The additional demand for solutions in the same or smaller footprints, at equivalent or lower layer count, increases the complexity of the problem. Both of these needs are met when large numbers of small z-axis interconnections or vias are rapidly formed in multilayer substrates to connect outerlayer circuitry to very dense innerlayers laden with fine lines and spaces. This technology translates to leading edge devices used in automotive and aerospace electronics, telecommunications, medical, computers, and a huge variety of electronic instruments and consumer appliances.

As shown in FIGS. 1A and 1B, a laminated substrate 10 is constructed by laminating alternating conductive layers 13 and dielectric layers 14 together. The conductive layers 13 are preferably formed from a conductive material, such as copper. The dielectric layers 14 are preferably made from laminates of high-temperature organic dielectric substrate materials, such as, but not limited to, polyimides and polyimide laminates, epoxy resins, organic materials, or dielectric materials comprised at least in part of polytetrafluoroethylene, with or without a filler. Glass fibrous materials such as FR4 and RCC can be used as well. Copper oxide layers 19 are preferably provided between adjacent conductive and dielectric layers for promoting adhesion of the conductive and dielectric layers.

Vias 15, 16, 17, 181 and 182 are vertical holes, formed in the laminated substrate 10 which, once plated, provide electrical connection between two or more conductive layers 13. If a via connects all conductive layers 13 it is called a through via, as indicated by 12 in FIG. 1A. If the via connects two or more conductive layers 13 to include one of the outer layers, it is called a blind via, as indicated by 11 in FIG. 1A and 181 and 182 in FIG. 1B. The via 181 is called blind top via while the via 182 is called blind bottom via. If the via connects two or more layers within the laminated substrate 10, not including either outer layer, it is called a buried via, as indicated by 17 in FIG. 1B. When a via is less than 0.1 mm (100 μm) in diameter, it is called microvia.

A via is characterized by a diameter D and an aspect ratio which is a depth to diameter ratio (h/D). Generally, vias are not uniform in diameter along their entire lengths. The entrance diameter of a via is usually larger than its exit diameter, as a result of side walls which are slightly tapered towards the exit, as indicated by 15 and 16 in FIG. 1A.

There are several methods of producing vias, including laser microvia drilling, photo-microvia formation, plasma etched microvia and mechanical microvia drilling. The one that is now clearly leading as emerging technology is laser microvia drilling which allows for the formation of high quality, high aspect ratio via holes at high speed.

Laser drilling involves focusing a high power laser beam onto the surface of a work piece. A portion of the beam is absorbed, the amount depending upon the material type and surface condition. The high intensity produced by absorption of high power and small focal spot results in heating, melting, and vaporization, or ablation, of the surface and underlying materials.

Laser drilling may be either percussion drilling or trepanning. Percussion laser drilling process involves a stationary beam and one or more pulses to penetrate the thickness of the material. With percussion drilling, the hole diameter is established by the beam diameter and power level.

Trepanning laser drilling involves contour cutting the via. The beam is moved along a circular path to produce a via having a diameter greater than that produced by a stationary focused beam (i.e. as in percussion drilling). Other trepanning patterns, such as spirals, ovals and squares, can be used instead. With trepanning, the hole diameter is limited only by the motion system travel.

A conventional laser drilling process may involve either of percussion drilling and trepanning, or both. For example, it is suitable to use the percussion drilling technique when the laser beam diameter is larger than the via diameter. This is a typical situation when a via of under 200 μm in diameter (D, in FIG. 3B) is to be formed using an infrared (1R) laser beam of about 250-600 μm in diameter (d₂, in FIG. 3B).

IR lasers have been known as an effective tool for removing dielectric materials in a single shot. However, these lasers are not capable of removing the outer layers of printed circuit boards which are usually copper foils. Thus, the outer layers of copper foils, in the region inside the via to be drilled, must be removed by chemical etching prior to the laser drilling. The remaining portion of the copper foil outside the via to be drilled functions as a conformal mask to limit the ablating effect of the laser beam within the etched window. This process is complicated due to the added chemical etching step.

Moreover, IR laser beams are generally not uniform in intensity: the beam intensity is strongest at the center and gradually decreases toward the edges. Therefore, vias formed by IR lasers often have a cup-like shape with undercuts at the peripheral regions at the bottom of the vias, as indicated by 36 in FIG. 3B. This undesirable defect may result in overplatings 37 of the conductive material in the subsequent plating step. The overplatings 37 significantly reduce the diameter of the via 30 to D′ which is much smaller than D: the via is then out of specification.

In an opposite example, when the laser beam diameter is smaller than the via diameter, trepanning drilling will be used. This is a typical situation when a via of about 75 μm in diameter is to be formed using an ultraviolet (UV) laser beam of about 25-30 μm in diameter (d₁ in FIG. 3B).

As shown in FIGS. 3A and 3B, the process begins with percussion drilling an initial hole 31 at the center of a via 30 to be drilled. The diameter of the initial hole 31 is defined by the diameter d₁ of a UV laser beam 35. The UV laser beam is then shifted radially outwardly, as indicated by 38, to a new position 32, and is moved along a trepanning path 32 around the initial hole 31. This trepanning step may be repeated until the diameter of the hole is expanded to the predetermined diameter D. The UV laser beam is caused to orbit around the via center for as many revolutions as is determined necessary for the particular depth of the via 30.

Apparently, due to the required multiple runs, the above trepanning process is not suitable for drilling relatively large, as compared with the laser beam diameter, and deep holes. Moreover, even though the UV lasers serve well in the removal of copper foils from the surfaces of circuit board panels, and hence no etching is required, they provide very tight process controls for dielectric material removal. The typical small diameter UV laser beams need to trepan the opening in order to remove the underlying dielectric material. This of course adds significant time to the laser processing of large panel areas, resulting in significantly high cost per via.

Moreover, the hole quality is not consistent from via to via, especially when the dielectric layer is made of glass based materials such as FR4 or RCC. It has been observed that walls of vias formed in such materials appear to have irregular quality which adversely affect the adhesion of plating materials in the subsequent plating step.

Thus, none of the above approaches can be adequately used to effectively and quickly form high quality vias in multilayer printed circuit boards, especially when the printed circuit boards are formed with alternating copper foils and glass fibrous layers, and/or when the vias to be drilled have relatively large diameters of about 50-150 μm. Moreover, there has been no effort to make use of both the IR and UV laser systems while avoiding drawbacks associated with each of the laser systems. A need is also exists for an improved laser trepanning technique with reduced time cycle.

### SUMMARY OF THE INVENTION

It is an object of the present invention to provide an advanced laser drilling technique which is suitable for forming uniform vias, having consistent quality and reliable depth, in a multilayer substrate such as a printed circuit board. The method is especially suitable when the printed circuit board is covered with a copper foil and when the vias to be drilled have relatively large diameters.

It is a further object of the present invention to provide a method of laser drilling which can be used to quickly and effectively form high quality vias with straight walls, a clean bottom, and without undercuts in the peripheral region of the via bottom.

It is another object of the invention to provide an improved laser trepanning technique which does not require excessive numbers of trepanning movements, and hence, reducing time cycle and cost.

It is yet a further object of the invention to provide a method of laser drilling utilizing both UV and IR lasers, thereby eliminating an etching step typically associated with the use of IR lasers, and avoiding the need of excessive laser beam runs typically associated with the use of UV laser.

These and other objects of the present invention are achieved by a method of forming a hole having a predetermined contour in a substrate. The method comprises the steps of a) percussion laser drilling an initial hole in the substrate at a point on the contour; b) trepanning laser drilling along the entire contour, starting from the initial hole, to form a peripheral channel separating a central portion of the hole from a remaining portion of the substrate; and c) laser ablating the central portion to form the hole having the predetermined contour.

In accordance with an aspect of the invention, the trepanning laser drilling is repeated until the peripheral channel has reached a predetermined depth. In accordance with another aspect of the invention, the percussion laser drilling and the trepanning laser drilling comprise using a first laser beam while the laser ablating comprises using a second laser beam.

The foregoing objects of the present invention are also achieved by a method of forming a hole having a predetermined contour in a laminated substrate. The laminated substrate has at least a first layer of a first material overlaying a second layer of a second material. First, an initial hole is formed through the first layer of the laminated substrate, at a point on the contour, by percussion laser drilling. Then, trepanning laser drilling is performed along the entire contour, starting from the initial hole, to form a peripheral channel separating a central portion of the hole from a remaining portion of the laminated substrate. The central portion comprises a cutoff piece of the first material and an island of the second material. Finally, the island of the second material is ablated by laser, simultaneously removing the cutoff piece of the first material, to form the hole having the predetermined contour.

In accordance with an aspect of the invention, the percussion laser drilling and the trepanning laser drilling comprise using a first laser beam having an energy density per pulse greater than an ablation threshold of the first material, while the laser ablating comprises using a second laser beam having an energy density per pulse greater than an ablation threshold of the second material but less than the ablation threshold of the first material.

In accordance with another aspect of the invention, the laminated substrate further has a third layer which underlies the second layer and defines a bottom of the hole, and the energy density per pulse of the second laser beam is less than an ablation threshold of the material of the third layer, whereby the second laser beam reflects off a surface of the third layer resulting in a clean bottom surface.

The foregoing objects of the present invention are also achieved by a method of forming a via of an intended diameter in a laminated substrate. The laminated substrate has at least a conductive layer overlaying a dielectric layer. First, a first laser beam, having an energy density per pulse greater than an ablation threshold of the conductive layer, is generated. Then, the first laser beam is used to percussion laser drill an initial hole through the conductive layer of the laminated substrate, at a point on a boundary of the via. The first laser beam is next trepanned along the boundary of the via, starting from the initial hole, to form a peripheral channel having an outer diameter substantially same as the intended diameter. The peripheral channel separates a central portion of the via from a remaining portion of the laminated substrate. The central portion comprises a cutoff piece of the conductive layer and an island of the dielectric layer. In the subsequent step, a second laser beam, having an energy density per pulse greater than an ablation threshold of the dielectric layer but less than the ablation threshold of the conductive layer, is generated. Finally, the second laser beam is used to ablate the island of the dielectric layer, simultaneously removing the cutoff piece of the conductive layer, to form the via having the intended diameter.

In accordance with an aspect of the invention, the first laser beam is a UV laser beam while the second laser beam is an IR laser beam.

### BRIEF DESCRIPTION OF THE DRAWINGS

The present invention is illustrated by way of example, and not by limitation, in the figures of the accompanying drawings, wherein elements having the same reference numeral designations represent like elements throughout, and wherein:

FIGS. 1A and 1B are cross-sectional views of a laminated substrate illustrating different via types which can be formed by the method of the present invention;

FIG. 2 is a schematic diagram of a laser system for performing the method of the present invention;

FIGS. 3A and 3B are plan and cross-sectional views, respectively, of a laminated substrate illustrating a conventional via formation process,

FIGS. 4A and 4B are plan and cross-sectional views, respectively, of a laminated substrate illustrating a via formation process in accordance with the present invention;

FIG. 5A is photomicrographs comparing the via formation process of the invention (circle trepanning) with the conventional via formation process (filled trepanning);

FIGS. 5B and 5C are enlarged photoimages of the vias formed by the processes shown in FIG. 5A, respectively; and

FIG. 6 is a photomicrograph showing a blind via formed in accordance with the method of the invention.

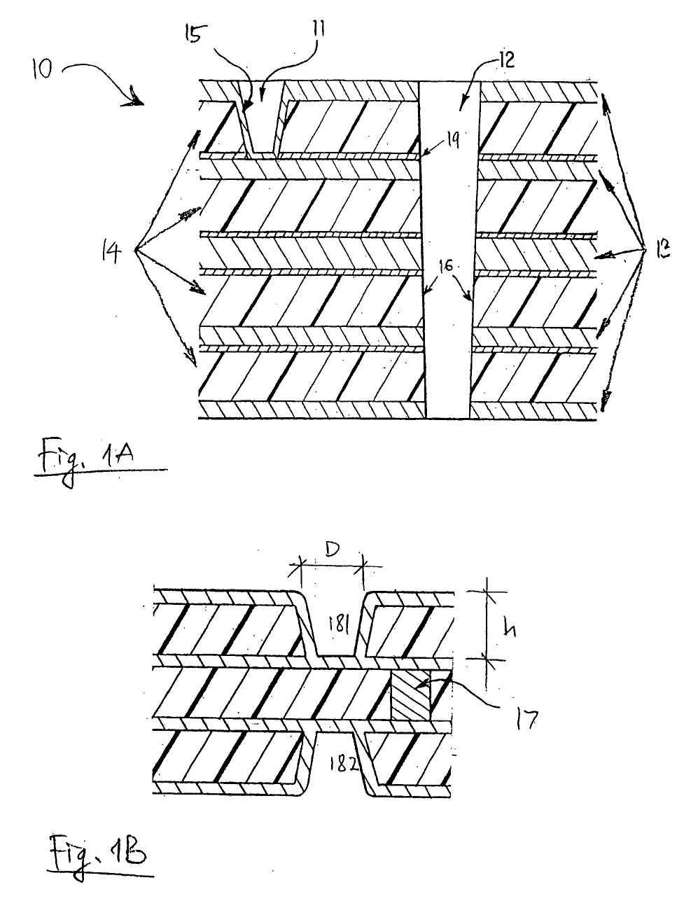

### BEST MODE FOR CARRYING OUT THE INVENTION

A method of and apparatus for circle laser trepanning according to the present invention are described, In the following detailed description, for purposes of explanation, numerous specific details are set forth in order to provide a thorough understanding of the present invention. It will be apparent, however, that the present invention may be practiced without these specific details. In other instances, well-known structures and devices are shown in block diagram form in order to simplify the drawing.

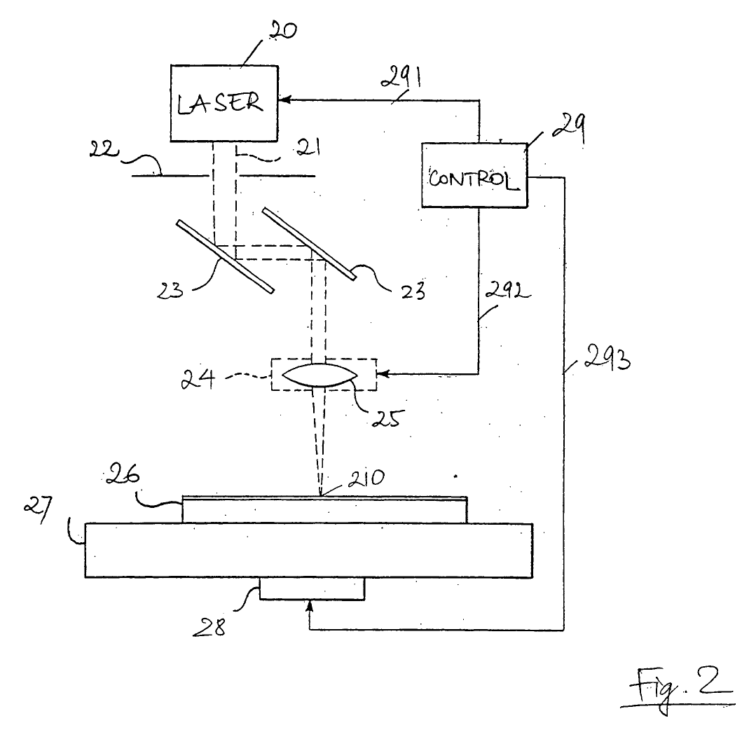

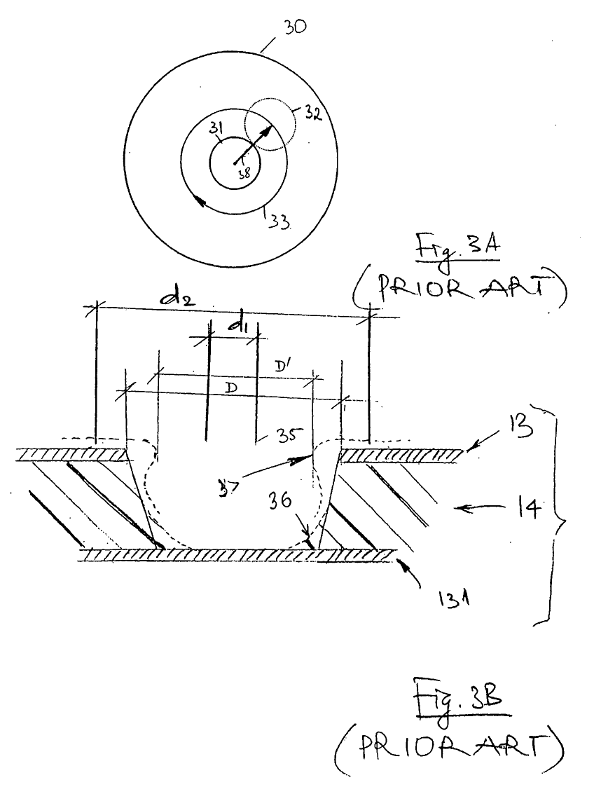

FIG. 2 is a schematic diagram of a laser system for performing the method of the present invention.

The laser system includes a laser source 20 for generating a pulsed laser beam 21. The laser 20 may be a short wavelength, such as UV, laser, a long wavelength, such as IR laser, or both. The laser beam 21 is transmitted through a laser optic system comprising mirrors 23 and a focusing lens 25, and is focused onto a workpiece 26, such as a laminated substrate. The laser beam 21 forms a focal spot 210 on the workpiece 26 placed on a X-Y positioning table 27. In the following description of preferred embodiments, laser beams having a circular focal spot 210 are used. However, the focal spot can be oval or of any suitable shape.

The laser system may include an aperture 22 for shaping the laser beam 21 by blocking the side lobes of the beam. The aperture 22 may also function as an attenuator which regulates the output power of the laser beam 21 in the manner known in the art. Although the aperture 22 is positioned immediately after the laser 20 as shown in FIG. 2, other arrangements are available as well. For example, the aperture 22 may be positioned between the focusing lens 25 and the workpiece 26. Likewise, the arrangement of remaining components of the laser system depicted in FIG. 2 is for illustrative purpose only.

The laser system further includes a control 29, such as a computer. Control 29 controls the position and/or movement of the focal spot 210 of the laser beam 21 with respect to the workpiece 26. For example, control 29 may issue a command 292 to an actuator 24 to move the focusing lens 25 in, e.g., the X direction. Another command 293 is issued to a driving mechanism 28 to move the positioning table 27 in, e.g., the Y direction. The combined X and Y motion allows the laser system to move the laser beam 21 in relation to the workpiece 26, to drill in the workpiece 26 a via having a desired contour. It is possible to hold one of the laser beam 21 and the workpiece 26 stationary, while moving the other in both X and Y direction. The movement of the laser beam 21 can be adjusted by the mirrors 23 as well.

Moreover, control 29 is operatively coupled to the laser 20 for establishing laser parameters such as direction, speed of the beam path, pulse repetition rate, pulse width and output power. To adjust, for example, the peak pulse power, control 29 may issue a command 291 to the laser 20 to implement a change in pulse repetition rate. The average output power, number of pulses per second, and pulse duration will be changed accordingly. An alternative approach to change the laser output power is to use the attenuator 22 as discussed above.

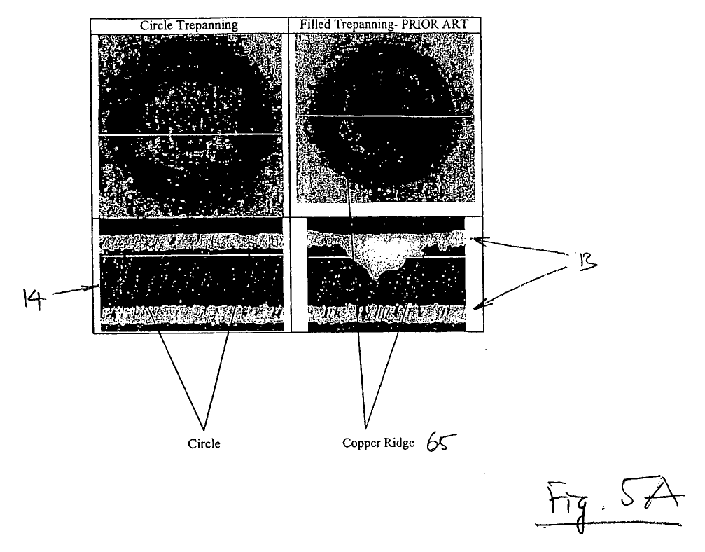

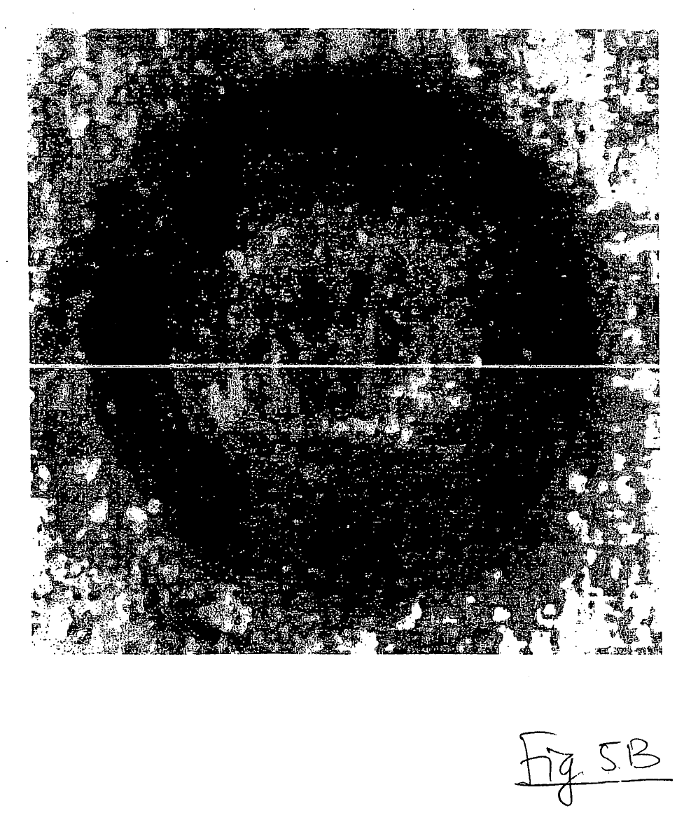

A via formation process in accordance with the present invention will be now described with reference to FIGS. 4A and 4B. Briefly, the process of the invention is a combined process of percussion and trepanning laser drilling steps which are performed alternatively taking into account the type of the laser used.

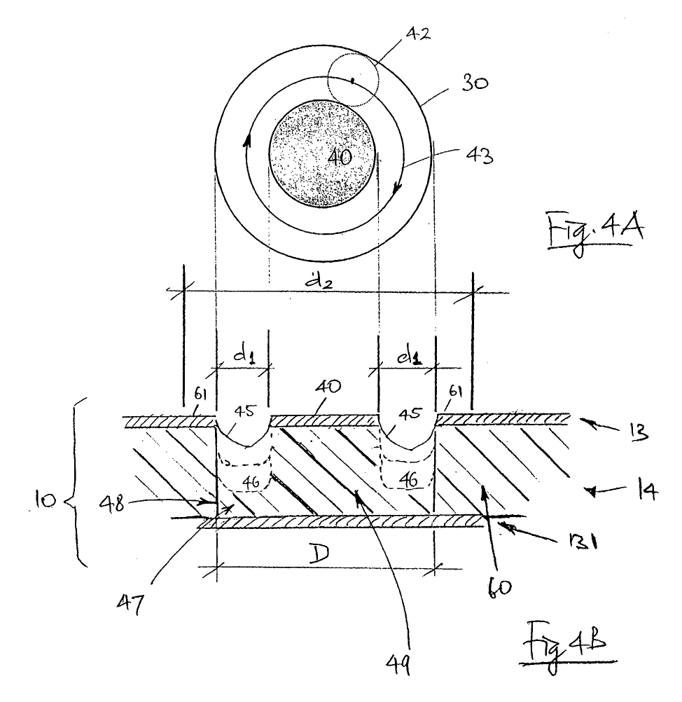

The process of the invention begins with percussion drilling an initial hole in the region of the via to be drilled. Unlike the conventional process in which the initial hole is formed in the center of the via, as shown at 31 in FIG. 3A, the initial hole in accordance with the invention is formed at the boundary of the via, as shown at 42 in FIG. 4A.

The trepanning drilling steps of the two processes are performed in different ways as well. In the conventional process, the laser has to trepan around the central initial hole to gradually expand the diameter of the via to a predetermined diameter. As mentioned in the foregoing discussion, the laser beam in this situation must scan through each and every point of the region inside the via. This is the reason why this conventional technique is called “filled” trepanning.

In contrast, the laser beam in accordance with the invention does not have to scan throughout the entire region inside the via. It is sufficient to trepan the laser beam along the boundary of the via, as shown by a path 43 in FIG. 4A. The central portion of the via remains intact in this trepanning drilling step. Thus, the process of the invention is called “circle” trepanning as opposed to the conventional “filled” trepanning.

More particularly, the laminated substrate 10 is first placed on the positioning table 27 of FIG. 2. The laser beam 21 is positioned so that the focal spot 210 is focused to a predetermined spot size inside of the region where the via is to be drilled. The output power level, the pulse repetition rate, the pulse length or duration and laser focal spot size are adjusted accordingly so that an adequate energy density per pulse is applied to the laminated substrate 10. The energy density per pulse of the laser beam 21 must be greater than an ablation threshold of the copper foil 13, and hence, is greater than an ablation threshold of the dielectric material 14. A suitable laser for this purpose is, for example, AVIA-type UV (ultraviolet) lasers made commercially available by Coherent Inc. Other types of short wavelength lasers can be used as well. In the case of AVIA-type UV (ultraviolet) lasers, the laser frequency is found to be optimal in the range of 20-27 kHz.

The UV laser beam 21 and the laminated substrate 10 are hold stationary relative to each other, and the percussion drilling is performed to remove a portion of the copper foil 13 through photo ablation. This step may require one or more pulses to penetrate the thickness of the copper foil 13. A portion of the underlying dielectric layer 14 may be removed during percussion drilling as well. The diameter of the initial hole 42 is established by the laser beam diameter d₁ and power level.

In the next trepanning drilling, the UV laser beam 21 is moved, with respect to the laminated substrate 10, along the circular path 43 to produce a peripheral channel 45 the outer wall of which actually defines the diameter of the via to be drilled. This can be accomplished given the size and position of the initial hole 42. Preferably, the laser settings are the same as the ones used in the previous percussion drilling step.

As can be seen in FIG. 4B, the peripheral channel 45 separates the central portion of the via, which comprises a cutoff piece 40 and an island 49, from the remaining portion of the laminated substrate 10. The cutoff piece 40 is an isolated disk of the copper foil 13 and is supported only by the island 49 of the dielectric layer 14.

When the peripheral channel 45 has been satisfactorily formed, the settings of the laser are adjusted to remove remaining materials inside the via 30. More specifically, the output power level of laser is decreased over the drilled via to an energy density level per pulse that does not exceed the ablation threshold of the copper foil 13. The new energy density level per pulse must, however, still be greater than the ablation threshold of the dielectric material 14 which is typically a glass based material such as FR4 or RCC types. Preferably, the UV laser is replaced with a long wavelength laser, such as an IR (CO₂) laser.

IR lasers have been known as capable of ablating dielectric materials but incapable of removing copper foils. As a rule, IR laser beams have spot size of about 250-600 μm, which is much larger than typical 25-30 μm spot size of UV laser beams. In the art of via formation where vias are usually formed with diameters of about 50-150 μm, the spot size of IR laser beams is often found larger than the required via diameter. The IR laser beams, however, can be focused or masked to a spot size relatively close to the via diameter, is necessary.

In a preferred embodiment of the invention, an IR laser, e.g. a CO₂ laser, having a beam size d₂ is used in the next step. As shown in FIG. 4B, the beam size d₂ is larger than the required diameter D of the via to be drilled. Therefore, there is no need to move the IR laser beam in relation to the laminated substrate 10. The next step of removing materials inside the via 30 may be considered as a second percussion drilling step from this point of view.

Since the IR laser beam cannot remove the copper foil 13, the portion 61 of the copper foil 13 outside the via 30 functions as a mask which protects the underlying portion 60 of dielectric layer 14 outside the via 30 from being affected by the IR laser beam. In contrast, the portion of dielectric layer 14 inside the via 30, which is either directly or indirectly exposed to the IR laser beam through peripheral channel 45, is thermally ablated. During this process, it has been observed that the cutoff piece 40 is also removed even though the power level of the IR laser beam is not sufficient to directly ablate the copper foil 13. As a result, the via 30 is formed with the predetermined diameter and substantially straight, smooth walls 48 defined by the preformed peripheral channel 45. Of particular note, the peripheral channel 45 may be formed with a desired depth 46 by repeating the trepanning drilling step. This can be easily accomplished by a repeat function available in the current UV laser systems. The number of repeated runs will depend on the thickness of the copper foil 13 and type of the laminated substrate 10, including but not limited to the thickness and type, e.g. glass, of the dielectric layer 14, and required aspect ratio.

If the via 30 to be drilled is a through via, the percussion drilling and trepanning drilling steps may be necessarily repeated several times for the UV laser-beam to cut through all conductive layers in the laminated substrate 10.

If the via 30 is a blind or buried via, the percussion drilling and trepanning drilling will be stopped before the UV laser beam cuts through a capture pad 131 which is also made of copper and is intended to be the bottom of the via 30. Then, the IR laser beam comes in and ablates all dielectric material contained in the space defined by the peripheral channel 45 and capture pad 131. Since the IR laser beam cannot cut through the capture pad 131, it will reflect off the capture pad 131, effectively ablating all dielectric material adjacent the capture pad 131. As a result, a clean via bottom is exposed, promoting the adhesion of a conductive material to be plated on the inner surfaces of the via 30 with the capture pad 131. No further post-pulse processing is required.

Other advantages of the via formation method in accordance with the present invention are also obvious given the above description and discussions. For example, the undercutting effect observed in the circumferential region at the bottom of a blind or buried via can be avoided in vias formed in accordance with the method of the invention. By deepening the peripheral channel 45 as far as the vicinity of the capture pad 131, the portion of the dielectric layer 14 in the possible undercut region will be removed not by the IR laser beam, which may not have sufficient ablating effect in the possible undercut region, but by the UV laser in the repeated percussion drilling step. Thus, vias formed by the method of the invention have superior quality compared to vias formed by the conventional method.

The method of the invention also allows for a reduced time cycle which is needed for loading, aligning, laser drilling and unloading a printed circuit board. While the time needed for loading and unloading a printed circuit board may not be different from the conventional process, the time needed for aligning and laser drilling, especially the later, is significantly shorten in the process of the invention.

For instance, in the conventional method, it is required to move the laser beam along multiple circular paths or a lengthy spiral path in order to remove the upper copper foil 13 alone. The process must be then repeated in several runs to deepen the via. In contrast, the process of the invention requires only single circular motion of a UV laser beam in trepanning drilling the peripheral channel 45. This takes less time than the traditional “filled” trepanning. Likewise, if repeated trepanning drilling is required, it will be much easier and faster to repeat a simple single circular movement than to repeat multiple circular concentric runs.

A drill speed test has been carried out to compare the drilling rates of the circle trepanning technique of the invention with the conventional filled trepanning technique. Test blind vias of 100 μm in diameter are drilled through a 18 μm thick copper foil and a 70 μm thick RCC layer of a test laminated structure. The filled trepanning drilling rate is 65 vias per second while the circle trepanning drilling rate is 90 vias per second. In other words, circle trepanning is approximately 40% faster then filled trepanning. Laser settings and microphotograph of the final via for circle trepanning in the above test are presented in Table 1 and FIG. 6, respectively. As can be seen in FIG. 6, the via formed in accordance with the method of the invention has substantially straight and smooth walls, and clean bottom surface.

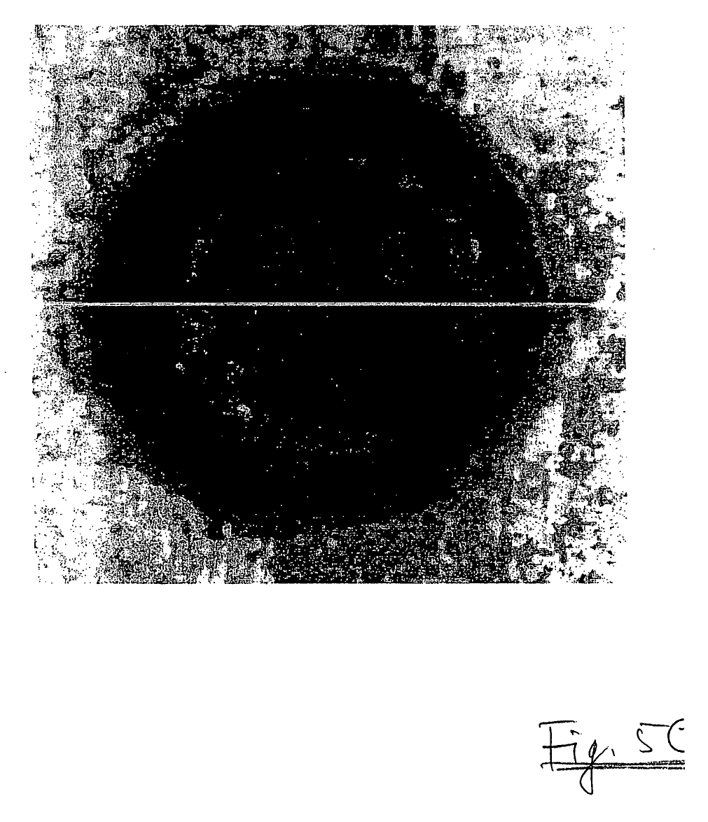

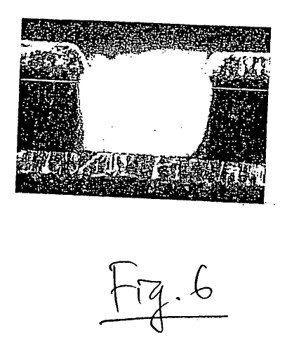

In addition, the WV laser is a very high energy source, a prolonged exposure to which may cause the exposed materials to react violently to the high energy. In the conventional process, the copper foil 13 is likely to be damaged in the region 61 adjacent to the boundary of the via 30 due to long, repeated-runs of the high power UV laser beam. As a result, one or more copper ridge 65, shown in FIGS. 5A and 5C, may be formed which is undesired. In contrast, the copper ridge is not observed in vias form by the method of the invention, as shown in FIGS. 5A and 5B.

Ablation of the underlying dielectric layer inside the via and the remaining copper disk 40 can be accomplished must faster by using an IR laser. Thanks to the large beam size of the IR laser, the IR laser beam can be hold stationary relative to the laminated substrate 10, instead of repeated trepanning required by the conventional process. It has been even demonstrated that multiple vias can be simultaneously formed by a single oversized IR laser beam. The process is thus simplified.

The IR laser needs to spend less time over given dielectric materials than the UV laser which often needs to be pulsed a greater number of times to ablate the same amount of dielectric materials. The aligning of the larger IR laser beam over the smaller via can be done quickly and with easy. The time cycle is thus shortened.

The IR lasers are cheaper to operate than the UV lasers. Thus, by combining UV and IR laser systems in one process, the process of the invention is much more cost effective than the conventional process in which only the UV laser is used.

The above advantages become more significant when the via to be drilled has a diameter much greater than the spot size of a UV laser beam, e.g. 150 μm as opposed to 30 m, and is relatively deep.

With respect to the known via formation method in which only the IR laser is used, the method of the invention requires less steps and time. For example, in accordance with the conventional IR laser drilling method, a mask of photoresist material must be formed around the region of the laminated substrate 10 where the via is to be drilled, and the copper foil 13 is chemically etched away. Only then will the IR laser be capable of penetrating deep into the underlying dielectric layer. The conventional process also requires removing of the mask. All of the above steps are not necessary in the process of the invention since the copper foil 13 is partially removed by a UV laser before ablating the dielectric material using a IR laser. The process is thus simplified.

Another advantage of the present invention over the known IR laser drilling method is elimination of the undercutting effect, as discussed above.

The process of the invention advantageously requires only one recipe to produce vias with various diameters, including microvias of under 100 μm in diameter. Though vias with diameter of over 200 μm are advantageously produced by mechanical drillers, the invention is not limited to formation of under 200 ∥m vias. High aspect ratio can be obtained as well. The process of the invention is found especially suitable for forming vias with aspect ratios of from 1:1 to 5:1.

The process of the invention is suitable to form vias which extend through multiple alternating conductive/dielectric layers. Vias of shapes other than circle can also be produced as long as the peripheral channel 45 can be formed along the boundary of the vias through trepanning drilling.

Multilayer printed circuit boards with vias/microvias formed therein by the method of the invention are demonstrated to have improved liability.

While there have been described and illustrated specific embodiments of the invention, it will be clear that variations in the details of the embodiments specifically illustrated and described may be made without departing from the true spirit and scope of the invention as defined in the appended claims.

What is claimed is:

1. A method of forming a hole having a predetermined contour in a substrate, said method comprising the steps of:
a) percussion laser drilling an initial hole in said substrate at a point on said contour;
b) trepanning laser drilling along the entire contour, starting from said initial hole, to form a peripheral channel separating a central portion of said hole from a remaining portion of the substrate; and
c) laser ablating said central portion to form said hole having said predetermined contour.

2. The method of claim 1, wherein said trepanning laser drilling is repeated until said peripheral channel reaches a predetermined depth.

3. The method of claim 1, wherein said percussion laser drilling and said trepanning laser drilling comprise using a first laser beam optimized to form said peripheral channel, and said laser ablating comprises using a second laser beam optimized to remove a material of said central portion.

4. The method of claim 3, wherein said first and second laser beams are generated by short wavelength and long wave length lasers, respectively.

5. The method of claim 1, wherein said initial hole has a size smaller than that of said hole.

6. The method of claim 1, wherein said hole is formed with substantially straight walls.

7. A method of forming a hole having a predetermined contour in a laminated substrate, said laminated substrate having at least a first layer of a first material overlaying a second layer of a second material, said method comprising the steps of:
a) percussion laser drilling an initial hole in said laminated substrate, through said first layer, at a point on said contour;
b) trepanning laser drilling along the entire contour, starting from said initial hole, to form a peripheral channel separating a central portion of said hole from a remaining portion of the laminated substrate, said central portion comprising a cutoff piece of said first material and an island of said second material; and
c) laser ablating said island of said second material, simultaneously removing said cutoff piece of said first material, to form said hole having said predetermined contour.

8. The method of claim 7, wherein said trepanning laser drilling is repeated until said peripheral channel reaches a predetermined depth.

9. The method of claim 7, wherein said percussion laser drilling and said trepanning laser drilling comprise using a first laser beam having an energy density per pulse greater than an ablation threshold of said first material, and said laser ablating comprises using a second laser beam having an energy density per pulse greater than an ablation threshold of said second material but less than said ablation threshold of said first material.

10. The method of claim 9, wherein said first and second laser beams are generated by UV and IR lasers, respectively.

11. The method of claim 7, wherein said initial hole has a size smaller than that of said hole.

12. The method of claim 7, wherein said hole is formed with substantially straight walls.

13. The method of claim 7, wherein said first layer is a conductive layer and said second layer is a dielectric layer.

14. The method of claim 7, wherein said laminated substrate further has a third layer underlying said second layer, and said hole is defined by said third layer and outermost walls of said peripheral channel.

15. The method of claim 14, wherein said third layer is made of said first material.

16. The method of claim 9, wherein said laminated substrate further has a third layer of a third material underlying said second layer, said energy density per pulse of said second laser beam is less than an ablation threshold of said third material, whereby said second laser beam reflects off a surface of said third layer resulting in a clean bottom surface of said hole.

17. A method of forming a via of an intended diameter in a laminated substrate, said laminated substrate having at least a conductive layer overlaying a dielectric layer, said method comprising the steps of:
a) generating a first laser beam having an energy density per pulse greater than an ablation threshold of said conductive layer;
b) using said first laser beam, percussion laser drilling an initial hole in said substrate, through said conductive layer, at a point on a boundary of said via;
c) using said first laser beam and a circular trepanning motion, trepanning laser drilling along the boundary of said via, starting from said initial hole, to form a peripheral channel having an outer diameter substantially same as said intended diameter, said peripheral channel separating a central portion of said via from a remaining portion of the laminated substrate, said central portion comprising a cutoff piece of said conductive layer and an island of said dielectric layer;
d) generating a second laser beam having an energy density per pulse greater than an ablation threshold of said dielectric layer but less than said ablation threshold of said conductive layer;
e) using said second laser beam, laser ablating said island of said dielectric layer, simultaneously removing said cutoff piece of said conductive layer, to form said via having said intended diameter.

18. The method of claim 17, wherein said trepanning laser drilling is repeated until said peripheral channel reaches a predetermined depth.

19. The method of claim 17, wherein said first and second laser beams are generated by UV and IR lasers, respectively.

20. The method of claim 17, wherein said first laser beam has a first diameter, defining a diameter of said initial hole, smaller than said intended diameter of said via.

21. The method of claim 17, wherein said second laser beam has a second diameter equal to or greater than said intended diameter of said via.

22. The method of claim 17, wherein said laminated substrate further has a capture pad underlying said dielectric layer, and said via is defined by said capture pad and outermost walls of said peripheral channel.

23. The method of claim 22, wherein said capture pad is made of a conductive material.

24. The method of claim 22, wherein said energy density per pulse of said second laser beam is less than an ablation threshold of said capture pad, whereby said second laser beam reflects off a surface of said capture pad resulting in a clean bottom surface of said via.

25. The method of claim 17, wherein said laminated substrate is a printed circuit board.

26. The method of claim 25, wherein said conductive layer is a copper foil.

27. The method of claim 25, wherein said dielectric layer is selected from the group consisting of glass, polyimide, and epoxy resin.

28. The method of clain 17, wherein said intended diameter is about 50-150 μm.

29. The method of claim 17, wherein said via has an aspect ratio of about 1:1 to 5:1.

30. The method of claim 20, wherein said first diameter of said first laser beam is about 25-30 μm.

31. The method of claim 21, wherein said second diameter of said second laser beam is about 250-600 μm.

32. The method of claim 17, further comprising the step of plating inner surfaces of said via with a conductive material.

33. The method of clain 17, wherein said via is formed with substantially straight walls.
